(19) United States
(12) Patent Application Publication
(10) Pub. No.: US 2004/0035304 A1
(43) Pub. Date: Feb. 26, 2004

(54) Centering member for a plane tool

(75) Inventor: Jean-Pierre Steiner, Crissier (CH)

Correspondence Address: OSTROLENK FABER GERB & SOFFEN, 1180 AVENUE OF THE AMERICAS, NEW YORK, NY, 100368403

(73) Assignee: Bobst SA

(21) Appl. No.: 10/645,163

(22) Filed: Aug. 21, 2003

(30) Foreign Application Priority Data
Aug. 22, 2002 (CH) 2002 1442/02

(51) Int. Cl. B30B 1/00

(52) U.S. Cl. 100/214

(57) ABSTRACT

Centering member of a plane tool useful for a packaging production machine, comprising a boss projecting from a base for allowing permanent fastening of the tool in at least one aperture in one of the sides of the plane tool without adding any mechanical fastening element and without adding any material or any adhesive element. The shape of the boss and of its head are disclosed.

### BACKGROUND OF THE INVENTION

The present invention relates to a centering member for a plane tool, preferentially used in a machine processing packaging, such as a platen press working paperboard, cardboard or plastic sheets, in order to obtain outlines of boxes.

Such a machine usually includes a feeding station, in which the sheets are taken one by one from the top of a pile to be conveyed to a feed table where they are arranged with a regular space on the machine axis. Each sheet can then be seized at its front edge by a gripper bar, which is arranged at its ends on gripper bar chains, and the sheet is thereby conveyed to the next processing stations. The sheet is thus conveyed into a die cutting station comprising a platen press provided with blades, and then into a stripping station where the waste is stripped from the sheet by pinching between a plurality of ejectors. Once the sheet has been die cut and its waste stripped, the sheet is finally conveyed into a delivery station where it is released by the gripper bar so as to fall crosswise on the top of a delivery pile.

To carry out the die cutting and waste stripping operations, the related stations are equipped with plane tools, which is usually made up of a rectangular shaped wooden plate, in which blades and ejectors are inserted.

The sheet is brought into the stripping station flat on a first working plane tool perforated according to the circumference of the pieces to strip. Ejectors and pressing devices are arranged into an upper stripping tool. That tool is alternatively moved in the vertical direction, with synchronism so that the tool is lowered right after the sheet reaches the perforated plane tool. A second plane tool, known as lower tool, is generally arranged below the plane tool and the second tool supports telescopic vertical pins laid out in connection with the ejectors of the upper plane tool. Thus, when the upper tool drops on the cut out sheet, the whole waste is gripped between the ejectors and the ejection pins and is pushed downwards and stripped from the sheet in only a single operation.

These plane tools are generally arranged in pull-out frames which allows their removal and reinstallation into the station by a single sliding motion through a side aperture into the machine intended for this purpose. To enable the die cutting of the sheet and the waste stripping in their respective station, with precision at very high rate (8,000 to 10,000 sheets/hour according to formats), it is necessary for each plane tool to be exactly arranged, longitudinally and laterally, in optimal register on the run axis of the sheets. This axis defines a central line of reference which is common for the side positioning of all tools in all stations. To this end, the plane tools are each equipped with a centering block fastened on the center line of the tool, into the front downstream edge of the stripping board. Thus, these centering blocks can either come to fit into a notch centered on the longitudinal reference axis and relatively machined in the machine, or come in catch between a cam and a stop of the fastening and centering device arranged in the pull-out frame of the plane tool. Examples of devices including stripping boards equipped with such centering blocks are illustrated in patents CH 690988, CH 691035 and in the patent application EP 1074353.

Resulting from molding, these centering blocks are usually made of hard plastic and are fastened in the plane tool by means of two wooden screws. For each new work, it is necessary to deal with the preparation of all plane tools before their infeed into the machine. It is during this preparation that the centering blocks are fastened, by screwing, on each tool intended for working into the machine.

However, the inconvenience of such a fastening method lies mainly in the set-up time needed for the fastening of each centering block. To this end, pre-drilled holes are needed for the guidance of the fastening screws. Being often of small size, these fastening screws are not easy to deal with and can easily escape from the hands of the assembler, increasing the time needed for fitting the centering block. Usually, when a screw falls, it is not found or simply not collected by the assembler, who, due to its own experience, is used to this kind of incident and thus provides himself in advance with additional screws. Consequently, the stock of screws intended for these blocks often disappear more quickly than the stock of the blocks themselves, constraining the assembler to obtain the necessarily needed screws from the storekeeper. Taking into account the hour wage of the assembler, the time needed for the fastening of the centering blocks, the price of the screws and the cost of their stock management, it appears finally that the cost price of such a centering block is completely ridiculous (approx. 4%) compared to the total amount defined by its assembly on the plane tool.

Moreover, the removable fastening system of these centering blocks suggests sometimes to a few diligent persons to still recover them, so that the final operation cost is almost doubled.

### SUMMARY OF THE INVENTION

The aim of the present invention is to obviate these inconveniences and to considerably reduce the set-up time of the centering blocks as well as the operation cost. For this purpose, the invention allows any tool to be equipped with a centering member, with a fastening operation that is very fast while being at the same time precise, solid and reliable. The centering member is advantageously fastened without any mechanical fastening element, such as screw, pin or rivet, and without any additional material or adhesive element against its surface. Thanks to its specific shape, the subject matter of the invention can be definitively fastened into the plane tool using a small mallet, or even by simple hand pressure. Its definitive fastening avoids any risk of recovery and produces a consumable product that can be discarded after use.

To this end, the present invention has as an aim a centering member of a plane tool useful for a packaging production machine, comprising a boss projecting from a base for allowing permanent fastening of the tool in at least one aperture in one of the sides of the plane tool without adding any mechanical fastening element and without adding any material or any adhesive element. The shape of the boss and of its head are disclosed.

Other features and advantages of the present invention will become apparent from the following description of the invention which refers to the accompanying drawings.

### BRIEF DESCRIPTION OF THE DRAWINGS

The invention will be better understood by studying an embodiment taken as a by no means restrictive example and illustrated by the enclosed figures in which:

FIG. 1 represents a perspective view of a centering member in conformity with the present invention,

FIG. 2 represents the same subject of the invention in a lower sight,

FIG. 3 represents a plane tool in which the centering member of the invention is intended to fasten itself.

### DETAILED DESCRIPTION OF A PREFERRED EMBODIMENT

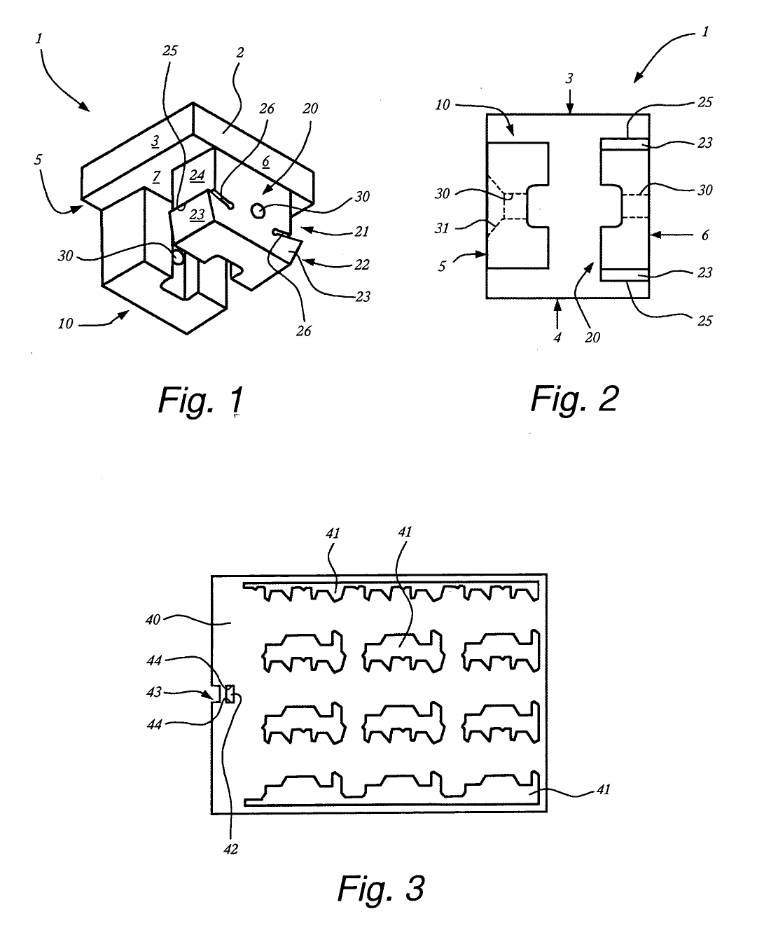

FIG. 1 represents a perspective view of a centering member 1 appearing as a stud shown at voluntarily exaggerated dimensions. The normal size of such a stud usually has a side of about 20 mm. The centering member 1 comprises a base frame 2, usually of square or rectangular shape, including two side faces 3, 4, a front face 5 and a back face 6. Two bosses 10, 20 emerge from the lower face 7 of the base frame 2 and are connected flush with the respective faces 5 and 6. The first boss 10 is a right parallelepiped, milled here with a groove in its interior or inward facing side.

The second boss 20 also is a right parallelepiped having a trunk 21 is cut into it. Below the trunk there is a prominent head 22 presenting at least one projection 23, and preferably two projections extending beyond the side faces 24 of the trunk 21. The projections 23 have oblique outward faces with prolongations converging above the head 22 and giving the projections a trapezoidal shape. Each face of these projections is defined at its base by a preferentially horizontal edge 25. Two grooves 26 are located at the joint of trunk 21 and head 22 giving the projections 23 a mechanical elasticity as compared to the rest of the boss 20. The head 22 appears thus as a claw with slightly elastic and deformable ends.

FIG. 2 represents the same centering member but viewed from below, showing a horizontal, drilled 30, passing right through the two bosses 10, 20. Preferentially, a conical countersink 31 is formed into the external front face of the boss 10, in the axis of the drilled passage 30.

As an example in FIG. 3, a plane tool 40, or stripping board, is illustrated, in which the member 1 is intended to be fastened in order to fulfill its centering operation at the time of the infeed of this tool into the machine.

FIG. 3 enables better understanding of the way in which the member of this invention is assembled with the tool for which it is intended, without any additional part required.

The example plane tool 40 is a stripping board on which the die cut sheets come and stop to be stripped from their waste. During this operation, the waste is stripped from the sheet, and passes toward the bottom throughout the apertures 41 of this board.

Generally near the downstream edge of the plane tool, an aperture 42 is provided so that the boss 20 can be inserted. A notch 43 is machined on the downstream edge of the same board allowing the first boss 10 to slip in there with a precise fit, flush with the downstream end of this board. Such apertures can advantageously be machined using a laser, for example. The assembly of the centering member 1 into the plane tool 40 is carried out while exerting, preferably on the upper face of the base frame 2, a vertical pressure downwards. The manufacturing tolerances for the plane tool and for the member 1 are such that they ensure a perfect fit of these two parts without any shift. The assembly of these two parts is blocked by the projections 23, whose edges 25 are supporting against the side walls 44 of the aperture 42 by pushing against these latter towards the outside. The head 22 does not emerge at all or emerges only partially from the lower surface of the plane tool 40.

In another embodiment, it is also possible to plan the total release of the head 22 from the lower surface of the plane tool so that the height of the trunk 21 is then appreciably equal to the thickness of the plane tool 40. In this case, the edges 25 are supported against the lower face of the tool and prevent any displacement of the centering member.

According to the amount of blanks to be die cut and according to their laying down on the sheet within the physical limits of the plane tool, the edge of the sheet may sometimes encroach on a small part of the space initially intended for the fitting of the centering member. In this case, it can happen that a part of this member must be cut down in order to ensure, for example, a correct stripping of a waste somewhat overflowing onto the surface of the aperture 42. However, if a too large portion of the centering member is cut down, its fastening system can weaken and either not be operational anymore or not sufficiently reliable to enable a permanent fastening. To obviate this inconvenience while maintaining the use of said member, it was intended to rigidify its fastening member while introducing a screw, a pin or a rivet, throughout the drilled passage 30. In this case, the fastening of the centering member according to the invention is not operated vertically, as it is the case in the current state of the technical field, but horizontally by means of a screw tightening itself in the thickness of the plane tool, parallel to the plan of the latter. This additional fastening system has the advantage of needing no space on the surface of the plane tool to be set into work.

An alternative to the present invention could consist in modifying the main shape of the centering member in order to further reduce the space used on the surface of the tool while preserving the fastening operation by clipping. However, the shape of the boss 20, and more particularly the shape of the trunk 21 and/or of the head 22, could also be very different from the shape shown as an example in FIGS. 1 and 2, without damage to the fastening embodiment described above. Also, the shape of the aperture 42 could also be subject to variations. It is the same for the boss 10 and for the related notch 43.

According to a preferred embodiment, the member of the present invention aims is intended to be inserted into the plane tool 40 so that the base frame 2 appears preferentially above the upper surface of said tool. However, it should also be possible that this base frame is countersunk in the thickness of the tool or is even turned upside down for supporting against the lower face of the latter.

The centering member as described here includes only one gripping boss 20. However, several gripping means may be provided to fit into as many apertures 42 or the boss 10 may be charged into a fastening boss throughout the notch 43.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. Centering member for a plane tool comprising means shaped for enabling permanent fastening of the member into at least one aperture spared in one of the sides of the plane tool without the addition of any mechanical fastening element and without the addition of any material or adhesive element.

2. The member of claim 1, wherein the means comprises a base;
at least one boss projecting from the base, the base comprising a trunk, a head on the trunk and a gripping means on the head for directly connecting with the plane tool.

3. The member of claim 2, further comprising a groove located at a joint between the trunk and the head, the groove being of a size to give the head a mechanical elasticity as compared to the remainder of the boss.

4. The member of claim 3, wherein the head is of such size relative to the thickness of the tool that when the head inserted into the aperture in the tool, the head is of such a height that the head is countersunk in the thickness of the plane tool in the head or the head emerges only partially out of one of the sides of the tool.

5. The member of claim 4, wherein the head comprises at least one projection sized and shaped to exert friction moving towards the outside of the plane tool, in the plan view direction of the tool.

6. The member of claim 3, wherein the head inserted into the aperture in the tool is of such a height that the head emerges completely out of one of the sides of the plane tool.

7. The member of claim 6, wherein the head comprises at least one projection which ends at an edge supported against one of the sides of the plane tool.

8. The member of claim 4, wherein the trunk of the boss is shaped and placed such that it is inserted without any shift into the aperture.

9. The member of claim 2, wherein the boss is bored with a horizontal hole.

10. The member of claim 2, wherein the trunk is a right parallelepiped and the head is trapezoidal in shape.
